(19) United States
(12) Patent Application Publication
(10) Pub. No.: US 2019/0350249 A1
(43) Pub. Date: Nov. 21, 2019

(54) EXTRACTION MECHANISM OF SHEET-LIKE FOOD AND METHOD OF EXTRACTING THE SHEET-LIKE FOOD USING THE MECHANISM

(71) Applicant: KAWASAKI JUKOGYO KABUSHIKI KAISHA, Kobe-shi, Hyogo (JP)

(72) Inventor: Kenji BANDO, Nishinomiya-shi (JP)

(73) Assignee: KAWASAKI JUKOGYO KABUSHIKI KAISHA, Kobe-shi, Hyogo (JP)

(21) Appl. No.: 16/473,938

(22) PCT Filed: Dec. 25, 2017
(86) PCT No.: PCT/JP2017/046397

§ 371 Date: Jun. 26, 2019

(30) Foreign Application Priority Data
Dec. 26, 2016 (JP) 2016-251466

(51) Int. Cl. A23P 20/20; A23L 7/196; A23L 17/60; B65H 29/46

(52) U.S. Cl. CPC A23P 20/20; A23L 7/1965; A23V 2002/00; B65H 29/46; A23L 17/60

(57) ABSTRACT

An extraction mechanism is an extraction mechanism of dried seaweed, configured to adhere the dried seaweed to molded rice ball. The mechanism includes an accommodation body configured to accommodate a plurality of dried seaweeds in a stacked manner, an opening formed in a bottom of the accommodation body and configured to expose a lowermost dried seaweed, and a control device. The control device is configured to extract the lowermost dried seaweed by positioning the opening of the accommodation body at a location near directly above the rice ball, and moving at least one of the accommodation body and the rice ball in a stacking direction of the dried seaweeds to change a relative distance between the lowermost dried seaweed exposed from the opening of the accommodation body and the rice ball.

### TECHNICAL FIELD

The present disclosure relates to an extraction mechanism of sheet-like food, such as dried seaweed, and a method of extracting the sheet-like food using the mechanism.

### BACKGROUND ART

Conventionally, in a seaweed wrapping machine for a rice ball or “Onigiri,” in order to wrap a dried seaweed or “Nori” around a molded rice ball, a seaweed aspirator, which ascends and descends, sucks and picks up the lowermost seaweed in a seaweed stacker where seaweeds are stacked, to feed the seaweed to a rice ball (see Patent Document 1).

### REFERENCE DOCUMENT OF CONVENTIONAL ART

### Patent Document

[Patent Document 1] JP2004-073129A

### DESCRIPTION THE DISCLOSURE

### Problems to be Solved by the Disclosure

However, in the conventional machine, since the seaweed aspirator for extracting the seaweed is necessary, the machine becomes a large scale or the machine cost goes up. Such a problem is common in a work in which sheet-like food other than the dried seaweed is wrapped around food, such as a rice ball.

The present disclosure is made in view of solving the above problem, and one purpose thereof is to easily extract dried seaweed for a rice ball.

### Summary of the Disclosure

In order to achieve the purpose, an extraction mechanism of sheet-like food, configured to adhere the sheet-like food to molded food is provided, which includes an accommodation body configured to accommodate a plurality of sheet-like foods in a stacked manner, an opening formed in a bottom of the accommodation body and configured to expose a lowermost sheet-like food, and a control device. The control device is configured to extract the lowermost sheet-like food by positioning the opening of the accommodation body at a location near directly above the food, and moving at least one of the accommodation body and the food in a stacking direction of the sheet-like foods to change a relative distance between the lowermost sheet-like food exposed from the opening of the accommodation body and the food.

According to this configuration, since the sheet-like food (dried seaweed) directly adheres to the food (rice ball) only by moving the accommodation body, which accommodates, for example, dried seaweeds, up and down in the stacking direction of the dried seaweeds, the dried seaweed can be extracted easily.

The extraction mechanism may further include a depressing member provided inside the accommodation body and configured to depress a topmost sheet-like food downwardly.

According to this configuration, since the topmost sheet-like food is depressed downwardly by the depressing member, the state where the lowermost sheet-like food is exposed from the opening can be maintained, even when the number of sheet-like foods is lowered. It becomes easier to extract the sheet-like food.

The extraction mechanism may further include a robot having a first robotic arm to which the accommodation body is attached at a tip end thereof

According to this configuration, only by moving the accommodation body attached at the tip end of the robotic arm up and down directly above the rice ball conveyed on, for example, a conveyor, the dried seaweed can directly be adhered to the rice ball.

The robot may further include a second robotic arm to which an end effector configured to be holdable of the food is attached at a tip end thereof

According to this configuration, only by moving, directly above the rice ball held by, for example, one of the robotic arm, the accommodation body attached at the tip end of the other robotic arm up and down, the dried seaweed can directly be adhered to the rice ball.

A method of extracting sheet-like food according to another aspect of the present disclosure is a method of extracting sheet-like food to be adhered to molded food using an extraction mechanism including an accommodation body configured to accommodate a plurality of sheet-like foods in a stacked manner, an opening formed in a bottom of the accommodation body and configured to expose a lowermost sheet-like food, and a control device. The control device extracts the lowermost sheet-like food by positioning the opening of the accommodation body at a location near directly above the food, and moving at least one of the accommodation body and the food in a stacking direction of the sheet-like foods to change a relative distance between the lowermost sheet-like food exposed from the opening of the accommodation body and the food.

### Effect of the Disclosure

According to the present disclosure, it has the configuration described above, which can easily extract the dried seaweed for the rice ball. The above purpose of the present disclosure, other purposes, features, and advantages will be made clear from the following detailed description of the suitable embodiments with reference to the accompanying drawings.

### BRIEF DESCRIPTION OF DRAWINGS

FIG. 1 is a perspective view illustrating the entire structure of an extraction mechanism of sheet-like food according to a first embodiment of the present disclosure.

FIG. 2 is a front view schematically illustrating the entire structure of one example of a robot in FIG. 1.

FIG. 3 is a schematic view illustrating one example of a structure of an end effector in FIG. 2.

FIG. 4 is a functional block diagram schematically illustrating a configuration of a control device of the robot in FIG. 2.

FIG. 5 is a flowchart illustrating one example of a procedure of a method of extracting the sheet-like food in FIG. 1.

FIGS. 6(A) and 6(B) are views illustrating one example of operation of the extraction mechanism of the sheet-like food in FIG. 1.

FIG. 7 is a view schematically illustrating a structure of an end effector according to a modification of the present disclosure.

FIG. 8 is a view schematically illustrating a structure of an end effector according to a second embodiment of the present disclosure.

### MODES FOR CARRYING OUT THE DISCLOSURE

Hereinafter, desirable embodiments will be described with reference to the drawings. Note that, in the following, the same reference characters are given to the same or corresponding components throughout the drawings to omit redundant description. Moreover, the drawings are to schematically illustrate each component for easier understandings. Further, a direction in which a pair of arms are extended is referred to as “the left-and-right direction,” a direction parallel to an axial center of a base shaft is referred to as “the up-and-down direction,” and a direction perpendicular to the left-and-right direction and the up-and-down direction is referred to as “the front-and-rear direction.”

### First Embodiment

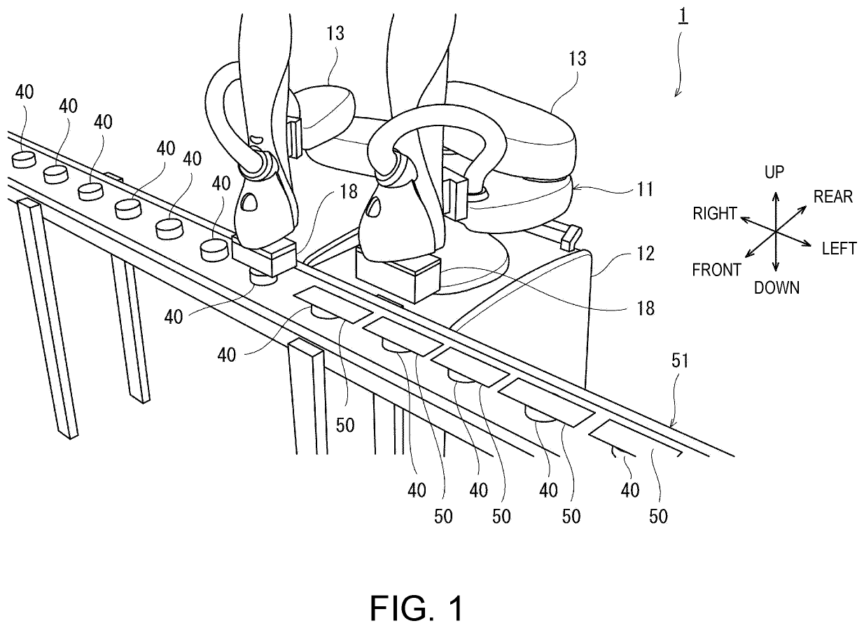

FIG. 1 is a perspective view illustrating the entire configuration of an extraction mechanism of sheet-like food according to a first embodiment of the present disclosure. The extraction mechanism of the sheet-like food is used for a work in which food formed in a sheet-like shape (hereinafter, referred to as “the sheet-like food”) is adhered to a molded food. As illustrated in FIG. 1, in this embodiment, food 40 is cooked rice molded in flat cylindrical shape (hereinafter, referred to as “the rice ball”). Sheet-like food 50 is dried seaweed for the rice ball, which is made for sushi rolls, and cut in a rectangular shape. In this embodiment, a case where an extraction mechanism 1 of the sheet-like food 50 according to the present disclosure is comprised of a robot 11 is described. The robot 11 is a dual-arm robot provided with a pair of robotic arms 13 supported by a base 12. However, the extraction mechanism 1 of the sheet-like food 50 is not limited to the structure comprised of the robot 11. Note that, although a horizontal articulated dual-arm robot is described as the robot 11, other robots of horizontal articulated and/or vertical articulated types may also be adopted. The robot 11 can be installed in a limited space corresponding to one person (for example, 610 mm×620 mm).

A belt conveyor 51 is disposed in front of the robot 11. In this embodiment, a workspace of a pair of robotic arms 13 is an area which covers a part of the belt conveyor 51. The belt conveyor 51 is a device which conveys a plurality of rice balls (40) from the right side to the left side of the robot 11 so that the rice balls (40) are separated at a given interval, and extends in the left-and-right direction.

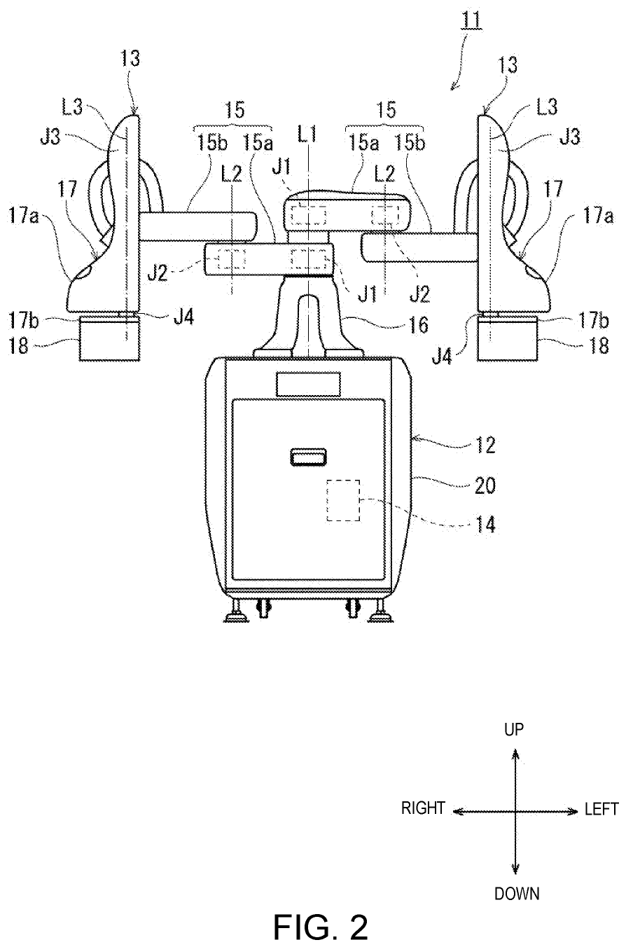

FIG. 2 is a front view schematically illustrating the entire structure of one example of the robot 11. As illustrated in FIG. 2, the robot 11 includes a base 12 fixed to a carrier, a pair of robotic arms (hereinafter, may simply be referred to as “the arm(s)”) 13 supported by the base 12, and a control device 14 accommodated in the base 12. Each arm 13 is a horizontal articulated robotic arm constructed to be movable with respect to the base 12, and includes an arm part 15, a wrist part 17, and an end effector 18. Note that the right arm 13 and the left arm 13 may have substantially the same structure. Moreover, the right arm 13 and the left arm 13 can operate independently or dependently.

In this example, the arm part 15 is comprised of a first link 15a and a second link 15b. The first link 15a is coupled to a base shaft 16 fixed to an upper surface of the base 12 by a rotary joint J1, and is rotatable on a rotation axis L1 passing through the axial center of the base shaft 16. The second link 15b is coupled to a tip end of the first link 15a by a rotary joint J2, and is rotatable on a rotation axis L2 defined at the tip end of the first link 15a.

The wrist part 17 is comprised of an elevating part 17a and a rotary part 17b. The elevating part 17a is coupled to a tip end of the second link 15b by a linear-motion joint J3, and is ascendable and descendable with respect to the second link 15b. The rotary part 17b is coupled to a lower end of the elevating part 17a by a rotary joint J4, and is rotatable on a rotation axis L3 defined at the lower end of the elevating part 17a.

The end effector 18 is coupled to the rotary part 17b of the wrist part 17. In this embodiment, the end effector 18 is provided to a tip end of each of the left and right arms 13. Note that the left and right end effectors 18 have the same structure.

Each arm 13 of the above structure has joints J1-J4. The arm 13 is provided, so as to be associated with the joints J1-J4, servo motors for drive (not illustrated), and encoders (not illustrated) which detect rotational angles of the servo motors, respectively. Moreover, the rotation axes L1 of the first links 15a of the two arms 13 are located on the same straight line, and the first link 15a of one arm 13 and the first link 15a of the other arm 13 are provided with a height difference therebetween.

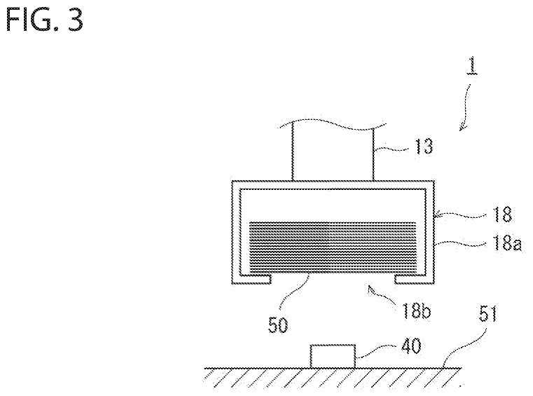

FIG. 3 is a schematic view illustrating a structure of the end effector 18 of the robot 11. As illustrated in FIG. 3, the end effector 18 is attached to a tip end (the rotary part 17b of the wrist part 17 in FIG. 2) of the arm 13, and includes an accommodation box 18a which accommodates a plurality of dried seaweeds (50), and an extraction opening 18b formed at the bottom of the accommodation box 18a.

The accommodation box 18a is constructed to accommodate the plurality of dried seaweeds (50) in a stacked manner. The extraction opening 18b opens at the bottom of the accommodation box 18a to expose the lowermost dried seaweed (50). Note that, although this figure illustrates the dried seaweed (50) accommodated inside the accommodation box 18a for sake of explanation, the situation inside the accommodation box 18a cannot be viewed from the exterior in the actual construction (refer to FIG. 1). That is, the accommodation box 18a has a shape like a tissue paper box being turned upside down. Since the accommodation box 18a is attached to the tip end of the arm 13, the position of the accommodation box 18a can be controlled to any location by controlling operation of the arm 13.

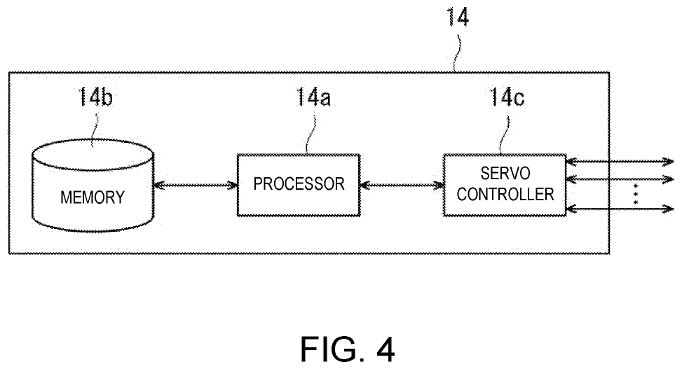

FIG. 4 is a functional block diagram schematically illustrating a configuration of the control device 14 of the robot 11. As illustrated in FIG. 4, the control device 14 includes a processor 14a, such as a CPU, a memory 14b, such as a ROM and/or a RAM, and a servo controller 14c. The control device 14 is a robot controller provided with a computer, such as a microcontroller, for example. Note that the control device 14 may be comprised of a sole control device 14 which carries out a centralized control, or may be comprised of a plurality of control devices 14 which collaboratively carry out a distributed control.

The memory 14b stores information on a basic program as the robot controller, various fixed data, etc. The processor 14a controls various operations of the robot 11 by reading and executing software, such as the basic program stored in the memory 14b. That is, the processor 14a generates a control command for the robot 11, and outputs it to the servo controller 14c. The servo controller 14c is configured to control the drive of the servo motors corresponding to the joints J1-J4 etc. of each arm 13 of the robot 11 based on the control command generated by the processor 14a.

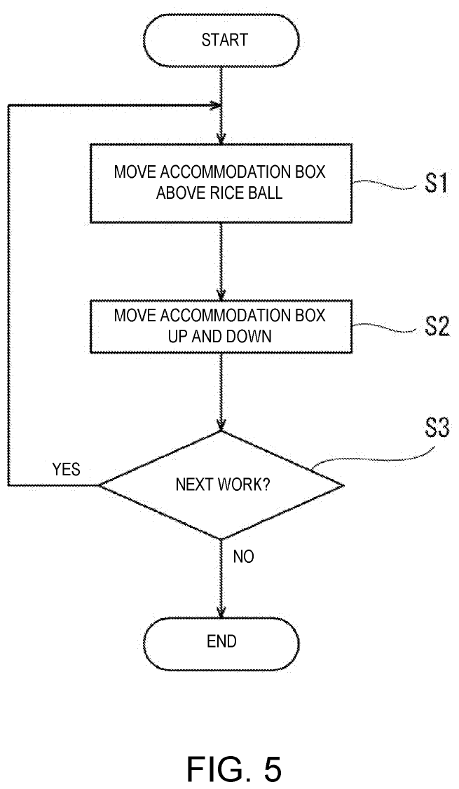

Next, operation of the extraction mechanism 1 of the sheet-like food 50 is described using a flowchart of FIG. 5. First, the control device 14 controls the operation of the arm 13, and carries out the positioning control in which the extraction opening 18b of the accommodation box 18a attached to the tip end of the arm 13 is positioned at a given preset position (Step S1 of FIG. 5). The given position is a location near immediately above the rice ball (40) disposed on the belt conveyor 51 (refer to FIG. 3). Note that, although the rice ball (40) on the belt conveyor 51 is stopped by suspending the operation of the belt conveyor 51 during the operation of the extraction mechanism 1, the belt conveyor 51 may operate and the control device 14 may carry out a control of the arm 13 to follow the operation of the belt conveyor 51.

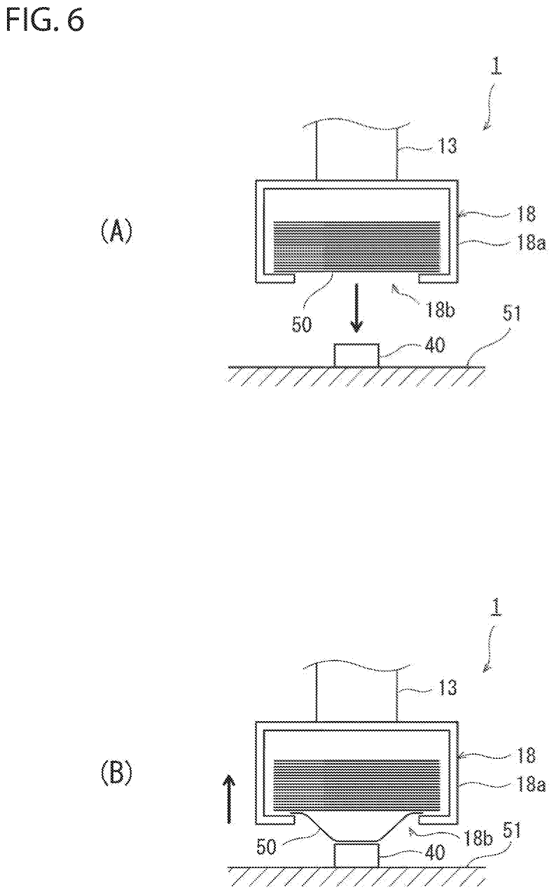

Next, as illustrated in FIGS. 6(A) and 6(B), the control device 14 controls the operation of the arm 13 to move the arm 13 up and down (Step S2 of FIG. 5). Accordingly, in the stacking direction of the dried seaweeds (50), a distance between the lowermost dried seaweed (50) exposed from the extraction opening 18b of the accommodation box 18a and the rice ball (40) is changed, and the lowermost dried seaweed (50) directly adheres to the rice ball (40). The operations at Steps 51 and S2 are repeated until the work is finished (Step S3 of FIG. 5). Thus, according to this embodiment, since the lowermost dried seaweed (50) directly adheres to the rice ball (40) only by moving the accommodation box 18a up and down, the dried seaweed (50) can be extracted easily.

### Modifications

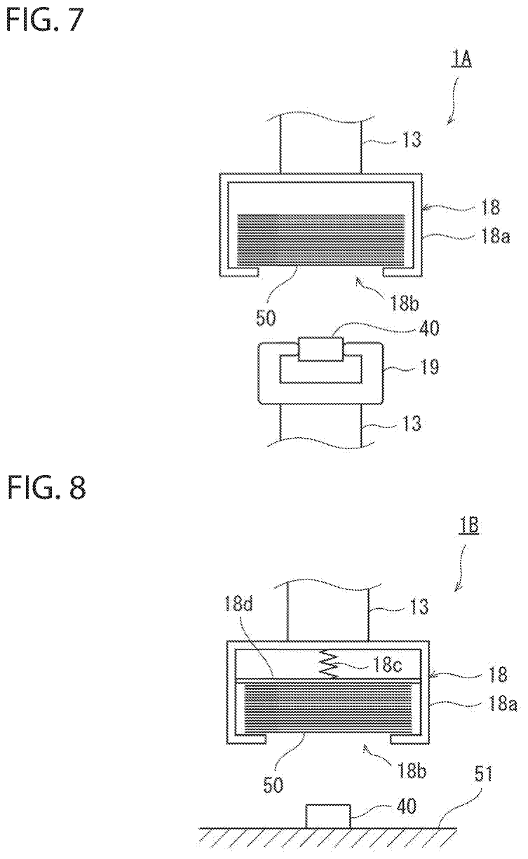

FIG. 7 is a view schematically illustrating a structure of an extraction mechanism 1A of the sheet-like food according to a modification of the present disclosure. As illustrated in FIG. 7, in this embodiment, it differs in that an end effector 19 configured to be holdable of the rice ball (40) is attached to the tip end of the other arm 13, as compared with the first embodiment (FIG. 3). By controlling the operation of the arm 13 to which the end effector 19 is attached, the rice ball (40) may be moved to change the relative distance between the lowermost dried seaweed (50) and the rice ball (40). Alternatively, by controlling the operation of both of the arm 13 to which the end effector 18 is attached, and the arm 13 to which the end effector 19 is attached, the accommodation box 18a and the rice ball (40) may be moved to change the relative distance. Such a configuration has a similar effect to this embodiment.

### Second Embodiment

Next, a second embodiment is described. In the following, description of the structure common to the first embodiment is omitted, and only different structure is described.

FIG. 8 is a view schematically illustrating a structure of an extraction mechanism 1B of the sheet-like food according to a second embodiment of the present disclosure. As illustrated in FIG. 8, in this embodiment, it differs in that the end effector 18 further includes a depressing member 18c which is provided inside the accommodation box 18a, and is configured to depress the topmost dried seaweed (50) downwardly, as compared with the first embodiment (FIG. 3). The depressing member 18c is comprised of an elastic body provided to a ceiling inside the accommodation box 18a, and a rectangular backing plate 18d attached to a lower end of the elastic body. Although the elastic body is a spring in this embodiment, it may be a rubber member. Here, the elastic body is disposed so that a lower surface of the backing plate 18d at the lower end of the elastic body touches the topmost dried seaweed (50). According to this embodiment, since the dried seaweed (50) is depressed downwardly by an elastic force of the elastic body which contacts the topmost dried seaweed (50), the state where the lowermost dried seaweed (50) is exposed from the extraction opening 18b can be maintained, even when the number of dried seaweeds (50) inside the accommodation box 18a is lowered. It becomes easier to extract the dried seaweed (50).

Note that, in this embodiment, although the depressing member 18c is comprised of the elastic body and the backing plate, it is not limited to this structure, as long as it is a member configured to depress the topmost dried seaweed (50) downwardly. For example, a member capable of blowing air may be provided inside the accommodation box 18a, and the topmost dried seaweed (50) may be depressed downwardly by the air blow. Alternatively, the dried seaweed (50) may be depressed downwardly by disposing a weight on the topmost dried seaweed (50).

### Other Embodiments

Note that, although the extraction mechanism 1 of the sheet-like food 50 according to the present disclosure is constructed by the robot 11 in the above embodiments, it is not limited to the robot, and it may be realized by a dedicated device capable of performing the positioning control.

Note that, although in this embodiment the sheet-like food 50 is the dried seaweed, other examples include meat (meat-wrapped rice ball), an omelet (omelet-wrapped rice ball), a deep-fried tofu (sushi pocket), and kelp (kelp-wrapped rice ball).

Note that, although the food 40 in the above embodiments is the cooked rice molded into the flat cylindrical shape, it is not limited to this shape, and it may be cooked rice molded into a triangular pillar shape. Moreover, instead of the rice, the rice cake made of glutinous rice may be used.

It is apparent for a person skilled in the art that many improvements and other embodiments of the present disclosure are possible from the above description. Therefore, the above description is to be interpreted only as illustration, and it is provided in order to teach a person skilled in the art the best mode that implements the present disclosure. The details of the structures and/or the functions may be changed substantially, without departing from the spirit of the present disclosure.

### INDUSTRIAL APPLICABILITY

The present disclosure is useful for the extraction work of the plurality of sheet-like foods, such as dried seaweeds.

DESCRIPTION OF REFERENCE CHARACTERS
1, 1A, 1B Extraction Mechanism
11 Robot
13 Robotic Arm
18 End Effector
18a Accommodation Box (Accommodation Body)
18b Extraction Opening (Opening)
18c Elastic Member (Depressing Member)
18d Backing Plate
40 Rice Ball (Food)
50 Dried Seaweed (Sheet-like Food)
51 Conveyor

1. An extraction mechanism of sheet-like food, configured to adhere the sheet-like food to molded food, comprising:
an accommodation body configured to accommodate a plurality of sheet-like foods in a stacked manner;
an opening formed in a bottom of the accommodation body and configured to expose a lowermost sheet-like food; and
a control device,
wherein the control device is configured to extract the lowermost sheet-like food by positioning the opening of the accommodation body at a location near directly above the food, and moving at least one of the accommodation body and the food in a stacking direction of the sheet-like foods to change a relative distance between the lowermost sheet-like food exposed from the opening of the accommodation body and the food.

2. The extraction mechanism of claim 1, further comprising a depressing member provided inside the accommodation body and configured to depress a topmost sheet-like food downwardly.

3. The extraction mechanism of claim 1, further comprising a robot having a first robotic arm to which the accommodation body is attached at a tip end thereof.

4. The extraction mechanism of claim 3, wherein the robot further includes a second robotic arm to which an end effector configured to be holdable of the food is attached at a tip end thereof.

5. A method of extracting sheet-like food to be adhered to molded food using an extraction mechanism including an accommodation body configured to accommodate a plurality of sheet-like foods in a stacked manner, an opening formed in a bottom of the accommodation body and configured to expose a lowermost sheet-like food, and a control device,
wherein the control device is configured to extract the lowermost sheet-like food by positioning the opening of the accommodation body at a location near directly above the food, and moving at least one of the accommodation body and the food in a stacking direction of the sheet-like foods to change a relative distance between the lowermost sheet-like food exposed from the opening of the accommodation body and the food.

6. The extraction mechanism of claim 2, further comprising a robot having a first robotic arm to which the accommodation body is attached at a tip end thereof.
